(19) United States
(12) Patent Application Publication
(10) Pub. No.: US 2017/0151492 A1
(43) Pub. Date: Jun. 1, 2017

(54) CARD RANDOMIZING METHOD FOR WAGERING GAMES

(71) Applicant: DEQ Systems Corp., St. Romuald (CA)

(72) Inventors: Robin Powell, Las Vegas, NV (US); Francisco Tejeda, Las Vegas, NV (US)

(21) Appl. No.: 15/298,525

(22) Filed: Oct. 20, 2016

Related U.S. Application Data
(63) Continuation of application No. 14/589,714, filed on Jan. 5, 2015, now abandoned.
(60) Provisional application No. 61/923,503, filed on Jan. 3, 2014.

(51) Int. Cl. A63F 1/12; G07F 17/32; A63F 3/00

(52) U.S. Cl. CPC A63F 1/12; A63F 3/00157; G07F 17/322; G07F 17/3293; A63F 2001/001

(57) ABSTRACT

A method for providing a randomized card engine for use in wagering card games which thwarts advantage play methods in live or electronic gaming formats, which includes the steps of shuffling, or simulating the shuffling of, a plurality of standard decks of physical playing cards to form a set of playing cards in a randomly-ordered condition, dividing the set of randomly-ordered playing cards into a plurality of subsets, and providing each subset of the plurality of subsets for independent use in a respective card wagering game.

### CROSS-REFERENCE TO RELATED APPLICATIONS

This application is a continuation of and claims priority to U.S. patent application Ser. No. 14/589,714 filed Jan. 5, 2015, which claims priority to U.S. Provisional Patent Application No. 61/923,503 filed Jan. 3, 2014, the disclosure of which is incorporated herein by reference.

### BACKGROUND OF THE INVENTION

The invention generally relates to systems and methods for providing multiple decks of randomly-ordered playing cards for use in the play of various games at a gaming table which are not reshuffled between game rounds.

Games such as baccarat, blackjack and various poker-based table games are popular games to play for entertainment. These are card-based wagering games which rely on one or more decks of randomly-ordered standard playing cards to provide a fair game to both the gaming operators and players. The decks are shuffled together, typically through the use of an automated card shuffler, and then dealt to players to form hands. The decks of cards may be shuffled at the gaming table and dealt or placed in a card dealing device, such as a card shoe, which facilitates single card removal while maintaining the other cards in a stacked position to prevent any cards from being inadvertently revealed. Once the card shoe is filled with shuffled cards it is brought to the gaming table for use in a game, such as baccarat.

Players have developed advantage play techniques in an attempt to maximize their mathematical advantage in the play of casino card games. Almost all of these techniques involve a player estimating the constituency of the group of remaining cards in the shoe or otherwise available to be dealt based on the knowledge or the “counting” of the cards that have already been dealt from the group. The technique therefore presumes that the entire group of cards contains one or more complete decks, that is, one or more decks containing the fifty-two standard cards forming a complete deck.

Gaming operators have an interest in preventing advantage play because it can negatively impact gaming revenue and make games less appealing to players who prefer to play games that are not subject to manipulation. Accordingly, new features that thwart advantage play without negatively impacting revenue, changing the odds of existing games or making game play less entertaining, among other things, are desirable.

### SUMMARY OF THE INVENTION

The invention is generally directed to a system and method for thwarting advantage play in wagering games involving physical playing cards or electronically-reproduced (virtual) versions thereof.

Some embodiments of the invention are directed to a method for providing groups of randomized cards, which effectively function as a randomized card engine for card wagering games, the method comprising the steps of: shuffling a plurality of standard decks of physical playing cards to form a set of playing cards in a randomly-ordered condition; dividing the e set of randomly-ordered playing cards into a plurality of subsets, wherein each subset contains an equal amount of cards; and providing each subset of the plurality of subsets for use in supplying randomized cards in a respective card wagering game.

In some embodiments, the aforementioned method further includes the step of drawing cards from each subset in each respective card wagering game.

In some embodiments, the aforementioned method further includes the step of inserting each subset of the plurality of subsets into a respective playing card shoe for use in providing randomized cards in a card wagering game.

In some embodiments, the aforementioned method further includes the step of delivering a playing card shoe including a subset of the plurality of subsets therein.

In some embodiments, the plurality of standard decks of physical playing cards is twenty-four decks of fifty-two cards.

In some embodiments, the plurality of subsets is three.

Some embodiments of the invention are directed to a method for providing a randomized card engine for live baccarat games comprising the steps of: shuffling twenty-four standard decks of physical playing cards using an automated shuffling device to form a set of randomly-ordered playing cards; dividing the set of randomly-ordered playing cards into a plurality of subsets, wherein each subset contains an equal amount of cards; and delivering or inserting each subset of the plurality of subsets into a respective playing card shoe for use in providing randomized cards in a card wagering game.

Some embodiments of the invention are directed to a computerized method for providing a randomized card engine for wagering games comprising the steps of: providing playing card data in a data storage device relating to each playing card of at least one standard deck of playing cards; a data processing device in communication with the data storage device and a random number generator facilitating use of the playing card data to simulate the random shuffling of a plurality of decks of playing cards into a virtual set of randomly-ordered playing cards and simulate the division of the virtual set into a plurality of virtual subsets, w therein each virtual subset contains an equal amount of playing cards; and displaying playing cards from the virtual subset on a display device in the play of a respective card wagering game.

In some embodiments, the aforementioned computerized method further includes the step of storing each virtual subset in memory. in some embodiments, the display device and data processing device are mounted in a housing, while in others they are remotely positioned and/or in communication over a network such as the world wide web.

Some embodiments of the invention are further directed to a card wagering game, including a gaming table surface having a configuration of designated areas to position gaming implements thereon for facilitating play of the card wagering game, a card dealing shoe, wherein the card dealing shoe includes a card staging space and a card delivery port for delivering cards in the play of the game, the card staging space including a randomized cards comprising a subset of randomly-ordered cards from a. plurality of subsets of randomly-ordered cards drawn from a set of a plurality of standard fifty-two card. decks of randomly-ordered playing cards.

In some embodiments of the card wagering game, the plurality of standard decks of physical playing cards is twenty-four decks of fifty-two cards.

In some embodiments of the card wagering game, the plurality of subsets is three.

### BRIEF DESCRIPTION OF THE DRAWINGS

FIG. 1 illustrates an exemplary method of the invention;

FIG. 2 illustrates an exemplary card delivery shoe for facilitating the methods of the invention; and

FIG. 3 is a schematic diagram of exemplary system components configured for use with methods according to some embodiments of the invention.

### DETAILED DESCRIPTION OF SOME EMBODIMENTS OF THE INVENTION

Exemplary applications of systems and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following example should not be taken as definitive or limiting either in scope or setting. In the detailed description that follows, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used and changes may be made without departing from the spirit and scope of the invention. Furthermore, the illustrations presented in this disclosure are generally intended to be idealized representations and are not necessarily to scale.

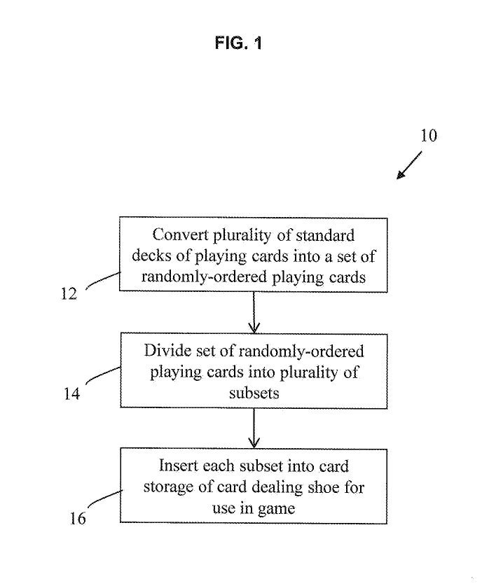

FIG. 1 illustrates a method 1 for providing a randomized card engine for live card wagering games. At step 12, a plurality of standard decks of physical playing cards are converted into a randomized condition to form a set of randomly-ordered playing cards. It should be readily apparent that this step may be facilitated by an electromechanically automated card shuffling device. In some embodiments, the plurality of decks is at least twenty-four, that is, one thousand two hundred and forty-eight playing cards without the joker cards included.

As shown in step 14, the set of randomly-ordered playing cards are divided into a plurality of subsets. In some embodiments, the subsets are divided such that each subset contains an equal or substantially equal amount of cards. In other embodiments, the subsets may include different amounts of cards. In the embodiment in which there are twenty-four, deck of cards, the set may be divided into three subsets of four hundred and sixteen cards each.

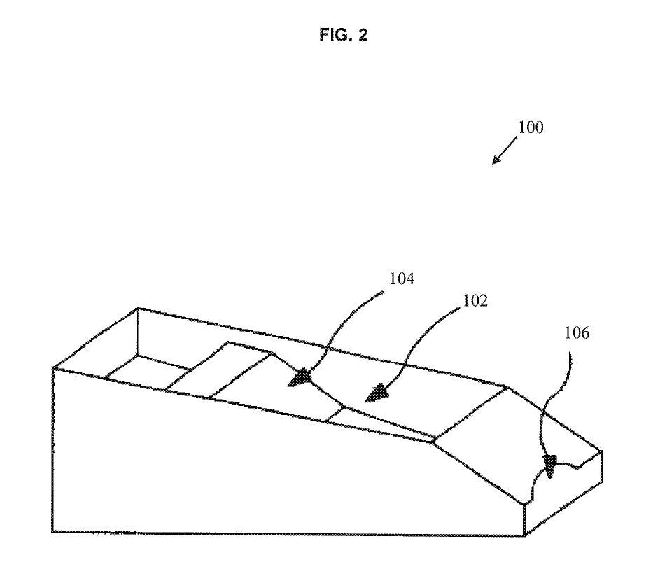

As shown in step 16, each subset of the plurality of subsets is inserted into a respective playing card shoe, such as playing card shoe 100 shown in FIG. 2. The subset of cards can be inserted into card staging space 102 between slide 104 and card delivery port 106. Playing, card shoe 100 may then be placed on a gaming table surface (not shown) having designated areas for gaming implements, such as dealt cards and wagers. A dealer may withdraw cards, preferably one at a time, from a card delivery port 106 on playing card shoe 100 in and during the play of a game.

It should be readily apparent that by forming subsets in step 14 subsequent to the randomizing of the full decks of cards in step 12, method 10 provides many benefits, including an unknown constituency of cards in each card dealing shoe, which among other things, eliminates an assumption relied upon by advantage play counting techniques. In other words, method 10 better ensures the integrity of the game by making the cards less easily countable to advantage players that wager based on the cards already dealt from a card dealing shoe and the presumption that each card shoe holds all fifty-two cards of each deck in a plurality of decks of playing cards.

It should also be readily apparent that any card shuffling device and/or card dealing shoe may be used in connection with, and benefit from, the methods of the invention described herein, and in any location. Cards may be randomized and divided into subsets in one or more remote locations, in a gaming establishment or elsewhere, such as prior to delivery to the gaming establishment, and the subsets transported to another location for use thereafter. The set of cards may include standard fifty-two decks or modified decks, such as decks in which specific cards are removed to impact the game play or house advantage, particularly in connection with games that have wagers which may be subject to some form of advantage play methods that rely on the presumption of the available cards consisting of complete decks, such as Blackjack.

The methods of the invention may also be implemented in a system, such as a terminal, kiosk or networked systems involving live gaming play being transmitted to stationary terminals, kiosks or portable devices for additional game play, in partial or full electronic gaming systems, such as those either involving real or virtual wagering or real or virtual multiple decks of cards, or in multiplayer gaming platforms in which decks of cards are electronically simulated through use of a random number generator being mapped to numbers or number sets that simulate a set of randomized cards in a plurality of decks, and then simulate one or more subsets of the set being used in a game.

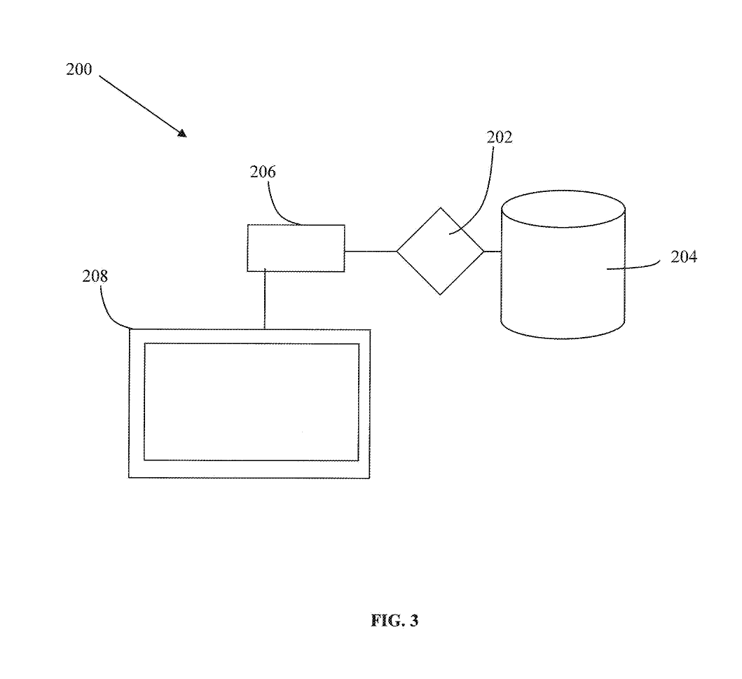

FIG. 3 illustrates an exemplary system 200 constructed in accordance with some embodiments of the invention. System 200 includes data processing device 202 in communication with a data storage device, database or memory 204, communication or data input/output device 206 and a display device 208. In some embodiments, display device 208 and data processing device 202, that is, the data processing device configured for providing the features of the invention, are mounted in the same housing, while in other embodiments they may be mounted separately. Exemplary embodiments include electronic gaming machines or tables, computers or smartphones. Memory 204 includes playing card data relating to each playing card in a standard deck of fifty-two playing cards, which may include images of each card. Processing device 202 simulates the random shuffling of a plurality of decks of playing cards by using the playing card data in memory 204 and a random number generator to form a virtual set of randomly-ordered playing cards, and then divides the virtual set into multiple virtual subsets. Each virtual subset may then be either transmitted, recorded or otherwise reproduced electronically and used in the play of a respective game, such as Baccarat, through the display of cards drawn from the virtual subset. Display device 208 may be mounted at player positions in a gaming table or may display a table layout configuration thereon for players to interact with and play the wagering game as if playing a non-virtual wagering game.

Those skilled in the art will readily appreciate that any of the systems and methods of the invention may include various computer and network related software and hardware, such as programs, operating systems, memory storage devices, data input/output devices, data processors, servers with links to data communication systems, wireless or otherwise, and data transceiving terminals, and may be a standalone device or incorporated in another platform, such as an existing electronic gaming machine, portable computing device or electronic platforms with multiple player positions. It should be readily apparent that additional computerized or manual systems may also be employed in accordance with the invention in order to achieve its full implementation as a system, apparatus or method.

While exemplary systems and methods, and applications of methods of the invention, have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth herein, by the claims and equivalents thereof.

What is claimed is:

1. A method for randomizing physical cards for card wagering games, the method comprising the steps of:
shuffling a plurality of standard decks of physical playing cards with a card shuffler to form a set of playing cards in a randomly-ordered condition;
dividing the set of randomly-ordered playing cards into three or more subsets of randomly-ordered playing cards; and
inserting a first subset of cards of the plurality of subsets into a first shoe for use in supplying randomized cards in a first respective card wagering game and inserting a second subset of the plurality of subsets into a second shoe for use in supplying randomized cards in a second respective card wagering game, such that neither the first card shoe nor the second shoe contain complete sets of standard 52 card decks thereby preventing a player from counting the constituency of cards in the first shoe or the second shoe.

2. The method according to claim 1, further comprising the step of drawing and dealing cards from the first subset in the first card wagering game and from the second subset in the second card wagering game.

3. The method according to claim 1, further comprising the step of insetting each subset of the plurality of subsets into a respective playing card shoe for use in providing randomized cards in a card wagering game.

4. The method according to claim 1, wherein the plurality of standard decks of physical playing cards is twenty-four decks of fifty-two cards.

5. The method according to claim 4, wherein at least one of the plurality of subsets is not provided to a wagering game table and not used in a wagering game.

6. In a card wagering game, including a gaming table surface having a configuration of designated areas to position gaming implements thereon for facilitating play of the card wagering game, a card dealing shoe, wherein the card dealing shoe includes a card staging space and a card delivery port for delivering cards in the play of the game, the card staging space including randomized cards comprising a selected subset of randomly-ordered cards, the selected subset taken from group randomly-ordered cards, the group of randomly-ordered cards having at least three times the number of cards as compared to a number of cards in the selected subset and the group drawn from sets of standard fifty-two card decks which are shuffled into randomly-ordered playing cards prior to the selected subset being taken from the group of randomly-ordered cards and cards remaining as part of the group of randomly-ordered cards after the selected subset is taken from group are not placed in the card dealing shoe and not used at the same wagering game.

7. The card wagering game according to claim 6, wherein the group of standard decks of physical playing cards is twenty-four decks of fifty-two cards.

8. The card wagering game according to claim 6, wherein a total of three subsets is taken from the group of randomly-ordered cards.

9. The card wagering game according to claim 6, wherein some cards from the group of randomly-ordered cards are not presented to a game table for use in game play.

10. A method for providing a random set of cards for use at a gaming table to prevent card counting, the method comprising:
at a location away from the game table, providing a group of playing cards comprising at least number of decks of 52 standard physical playing cards;
at a location away from the game table, shuffling the group of playing cards with a card shuffler to generate a shuffled group of playing cards;
at a location away from the game table, removing a set of cards from the shuffled group of playing cards to create the set of cards and a remaining group of cards, the set of cards having an unknown constituency of cards in relation to the group of playing cards to prevent a player from counting into a card dealing shoe containing the set of cards to gain an advantage;
inserting the set of cards into a card dealing shoe at the game table while the remaining group of cards is at a separate wagering game;
dealing card hands at the game table using cards from the set of cards but not cards from the remaining group of cards.

11. The method according to claim 10, wherein a second set of cards is taken from the remaining group of cards and provided to a separate wagering game table.

12. The method according to claim 10, wherein not all cards from the remaining group of cards are formed into sets of cards.

13. The method according to claim 10, wherein the group of playing cards is 1248.

14. The method according to claim 10, wherein not only an order but also a distribution of cards in the set of cards is unknown.

15. The method according to claim 10, wherein a second set of cards is formed and a third set of cards is formed and each set of cards has the same number of cards.

16. The method according to claim 10, wherein a second set of cards is formed and the second set of cards and the first set of cards, if combined, are not dividable into complete sets of 52 card deck.
